(19) United States
(12) Patent Application Publication
(10) Pub. No.: US 2026/0073434 A1
(43) Pub. Date: Mar. 12, 2026

(54) PRODUCT GROUP CUSTOMER GROUP EXTRACTING DEVICE, PRODUCT GROUP CUSTOMER GROUP EXTRACTING METHOD, AND PRODUCT GROUP CUSTOMER GROUP EXTRACTING PROGRAM

(71) Applicant: NIPPON TELEGRAPH AND TELEPHONE CORPORATION, Tokyo (JP)

(72) Inventors: Sun Yeong KIM, Tokyo (JP); Keita NISHIMOTO, Tokyo (JP); Takuya TEZUKA, Tokyo (JP); Saori OJI, Tokyo (JP); Sayaka TERANAKA, Tokyo (JP); Shinya OI, Tokyo (JP); Susumu YAMAMOTO, Tokyo (JP)

(73) Assignee: NIPPON TELEGRAPH AND TELEPHONE CORPORATION, Tokyo (JP)

(21) Appl. No.: 19/107,520

(22) PCT Filed: Sep. 8, 2022
(86) PCT No.: PCT/JP2022/033801

§ 371 Date: Feb. 27, 2025

(51) Int. Cl. G06Q 30/0601

(52) U.S. Cl. CPC G06Q 30/0605

(57) ABSTRACT

An estimation unit of a product group and customer group extraction device estimates a purchase purpose for which a customer has purchased a product, on the basis of history information including customer information for identifying the customer, product information on the product purchased by the customer, and date and time information of purchase of the product. A generation unit of the product group and customer group extraction device generates learning data from the history information added with the purchase purpose. An extraction unit of the product group and customer group extraction device clusters the learning data for each customer on the basis of the purchase purpose to extract product groups, and extracts the customer group on the basis of similarity of the product groups extracted for each of a plurality of the customers.

### TECHNICAL FIELD

The disclosed technology relates to a product group and customer group extraction device, a product group and customer group extraction method, and a product group and customer group extraction program.

Waste loss caused by a difference between an order quantity and a sales quantity is a financial problem in the retail industry. In particular, fresh products such as meat and vegetables, and daily sales products such as rice balls, packed lunches, and dairy products have a relatively short sales time limit, so that they are relatively likely to be discarded. In a case where the order quantity is set to be small with respect to actual demand for fear of left over, on the other hand, there is a possibility that products run out leading to a loss of sales opportunities and thus to customer churn.

Therefore, methods of predicting daily demand for each product has been proposed which are based on daily sales performance in an entire store in consideration of the influence of day of week, season, climate, and the like. Supermarkets and convenience stores that sell daily sales products are especially used by nearby residents for the purpose of procuring daily meals and ingredients, and thus it is assumed that daily customer fluctuations are small. The supermarkets and the convenience stores that sell the daily sales products can therefore predict the actual demand, as a stable probability event, by summarizing the purchase of many customers. Each purchase event, on the other hand, is a complicated event influenced by different factors for each customer. A number of purchases sufficient for the demand prediction therefore cannot be obtained and the demand prediction for each product is very difficult depending on the size of the store.

### CITATION LIST

### Non Patent Literature

Non Patent Literature 1: Tomoharu Iwata Shinji Wanatabe Takeshi Yamada Naonori Ueda: Topic Tracking Model for Analyzing Consumer Purchase Behavior, IJCAI International Joint Conference on Artificial Intelligence, pp. 1427-1432 (2009)

### SUMMARY OF INVENTION

### Technical Problem

Waste loss is typically more serious in small-scale stores than in large-scale stores; therefore, the demand prediction with higher accuracy is required for small-scale stores. Small-scale stores, however, have smaller sales volumes, and the prediction tends to be difficult.

The disclosed technology has been made in view of the points described above, and an object of the disclosed technology is to reduce the possibility of discarding products, in stores where it is difficult to predict demand for each product, by enabling grasping of a customer structure of the store, marketing, and demand prediction.

### Solution to Problem

The first aspect of the present disclosure is a product group and customer group extraction device including: an estimation unit that estimates a purchase purpose for which a customer has purchased a product, on the basis of history information including customer information for identifying the customer, product information on the product purchased by the customer, and date and time information of purchase of the product; a generation unit that generates learning data from the history information added with the purchase purpose; and an extraction unit that clusters the learning data for each customer on the basis of the purchase purpose to extract product groups, and extracts customer groups on the basis of similarity of the product groups extracted for each of a plurality of the customers,

The second aspect of the present disclosure is a product group and customer group extraction method in which: an estimation unit estimates a purchase purpose for which a customer has purchased a product, on the basis of history information including customer information for identifying the customer, product information on the product purchased by the customer, and date and time information of purchase of the product; a generation unit generates learning data from the history information added with the purchase purpose; and an extraction unit clusters the learning data for each customer on the basis of the purchase purpose to extract product groups, and extracts customer groups on the basis of similarity of the product groups extracted for each of a plurality of the customers.

The third aspect of the present disclosure is a product group and customer group extraction program for causing a computer to function as each unit constituting the product group and customer group extraction device described above.

### Advantageous Effects of Invention

According to the disclosed technology, the possibility of discarding products, in stores where it is difficult to predict the demand for each product, can be reduced by enabling grasping of a customer structure of the store, marketing, and demand prediction.

### BRIEF DESCRIPTION OF DRAWINGS

FIG. 1 is a block diagram illustrating hardware components of a product group and customer group extraction device.

FIG. 2 is a block diagram illustrating an example of functional components of the product group and customer group extraction device.

FIG. 3 is a diagram illustrating a configuration example of a history database.

FIG. 4 is a diagram illustrating an example of learning data in which a purchase content in one purchase is set as one record and added with customer information and a purchase purpose as metadata.

FIG. 5 is a diagram illustrating an example of the learning data in which all purchase contents during a learning period are aggregated into one record and added with the customer information and the purchase purpose as metadata.

FIG. 6 is a diagram illustrating an example of the learning data in which a product name, customer information, and the purchase purpose are integrated into one sentence.

FIG. 7 is a diagram illustrating an example of the learning data which is a matrix obtained by connecting a product purchase matrix and purchase purpose information to each other.

FIG. 8 is a diagram illustrating an example of a cluster screen.

FIG. 9 is a diagram illustrating an example of a ham cutlet cluster screen.

FIG. 10 is a diagram illustrating an example of a hamburger cluster screen.

FIG. 11 is a flowchart illustrating a flow of product group and customer group extraction processing.

### DESCRIPTION OF EMBODIMENTS

Hereinafter, an example of an embodiment of the disclosed technology will be described with reference to the drawings. Note that, in the drawings, the same or equivalent components and portions are denoted by the same reference signs. Further, dimensional ratios in the drawings are exaggerated for convenience of description and thus may be different from actual ratios.

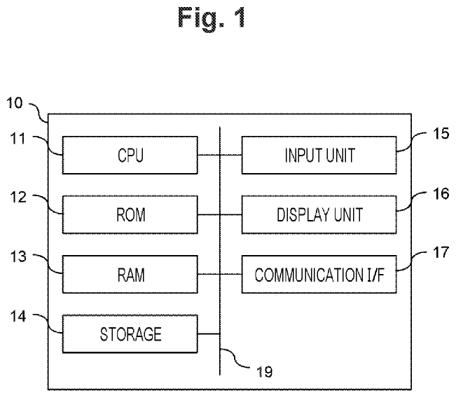

FIG. 1 is a block diagram illustrating hardware components of a product group and customer group extraction device 10 according to the present embodiment. As illustrated in FIG. 1, the product group and customer group extraction device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit that executes various programs and controls each unit. That is, the CPU 11 reads a program from the ROM 12 or the storage 14, and executes the program using the RAM 13 as a working area. The CPU 11 controls, in accordance with the program stored in the ROM 12 or the storage 14, each of the components described above and carries out various types of arithmetic processing. In the present embodiment, the ROM 12 or the storage 14 stores a product group and customer group extraction program for executing product group and customer group extraction processing to be described later and a history database 200.

The ROM 12 stores various programs and various data. The RAM 13, as the working area, temporarily stores a program or data. The storage 14 includes a storage device such as a hard disk drive (HDD) or a solid state drive (SSD), and stores various programs including an operating system and various data.

The input unit 15 includes a pointing device such as a mouse and a keyboard, and is used to perform various inputs.

The display unit 16 is, for example, a liquid crystal display which displays various information. The display unit 16 may also function as the input unit 15 by adopting a touch panel system.

The communication I/F 17 is an interface for communicating with other devices. A wired communication standard such as Ethernet (registered trademark) or FDDI or a wireless communication standard such as 4G, 5G, or Wi-Fi (registered trademark) is used for the communication, for example.

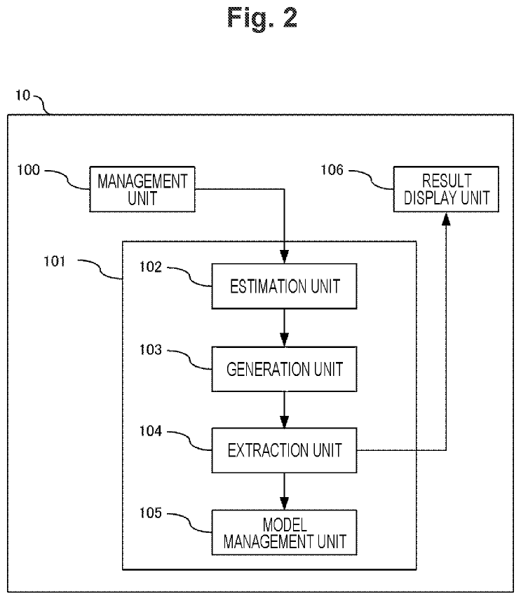

Next, functional components of the product group and customer group extraction device 10 will be described. FIG. 2 is a block diagram illustrating an example of the functional components of the product group and customer group extraction device 10. As illustrated in FIG. 2, the product group and customer group extraction device 10 includes, as the functional components, a management unit 100, a cluster extraction unit 101, and a result display unit 106. Further, the cluster extraction unit 101 includes an estimation unit 102, a generation unit 103, an extraction unit 104, and a model management unit 105. Each functional component is implemented by the CPU 11 reading the product group and customer group extraction program stored in the ROM 12 or the storage 14, developing the product group and customer group extraction program in the RAM 13, and executing the product group and customer group extraction program.

The management unit 100 manages the history database 200. Specifically, the management unit 100 stores, in the history database 200, history information on a history of product purchases collected from a register, a payment system, or the like of a store. The management unit 100 then reads the history database 200 and passes the history information to the estimation unit 102.

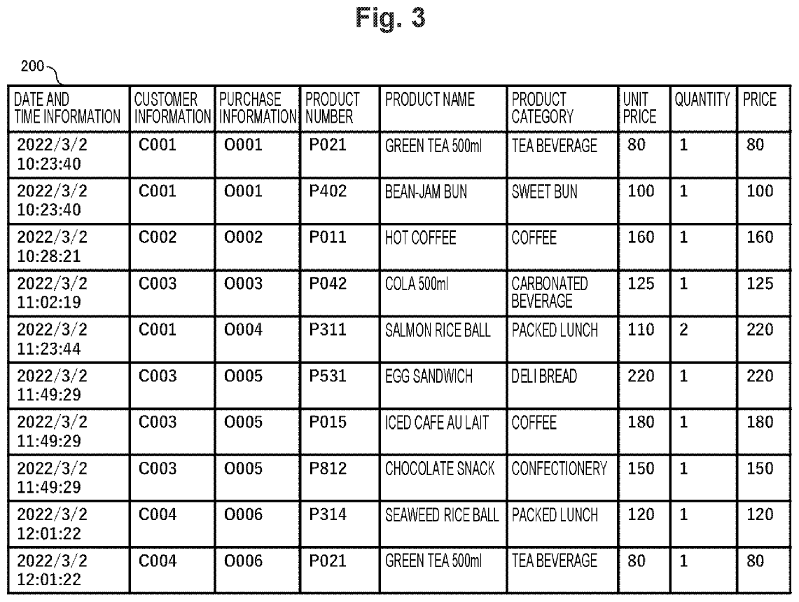

FIG. 3 illustrates an example of the history database 200. Each row indicates history information in FIG. 3. The history information includes customer information for identifying the customer, product information on the product purchased by the customer, and date and time information of purchase of the product. Specifically, as illustrated in FIG. 3, the history information is information in which date and time information, customer information, purchase information, a product number, a product name, a product category, a unit price, a quantity, and a price are associated with each other.

The date and time information is information indicating date and time when a customer purchased a product. The customer information is information for identifying the customer who purchased the product at a purchase date and time indicated by associated date and time information (hereinafter, also simply referred to as “a purchase date and time”). The purchase information is information for identifying a purchase act performed by the customer at an associated purchase date and time. The product number is a number for identifying the product purchased by the customer at the associated purchase date and time. The product name is a name of the product identified by an associated product number. The product category is a category of the product identified by the associated product number. The unit price is a unit price of the product identified by the associated product number. The quantity is a quantity of the purchased products identified by the associated product number. The price is a total amount achieved by the purchase act identified by the associated purchase information.

The estimation unit 102 estimates, on the basis of the history information passed from the management unit 100, a purchase purpose for which the customer has purchased the product. The estimation unit 102 estimates, for example, the product category indicated by the product information as the purchase purpose.

The estimation unit 102 may also classify a purchase time indicated by the date and time information into any time zone and estimate the classified time zone as the purchase purpose. This is because there is a certain purchase range for each purchase purpose of the customer, and is assumed that the purchase range is switched according to the time zone. In a case where the opening hours of the store are from 9:00 to 21:00, for example, the estimation unit 102 classifies the purchase time from 9:00 to 11:00 as “morning”, and classifies the purchase time from 11:00 to 14:00 as “daytime”. The estimation unit 102 also classifies the purchase time from 14:00 to 17:00 as “evening”, and classifies the purchase time from 17:00 to 21:00 as “night”.

In this case, segments of the respective time zones may be fixed or may be different for each piece of the customer information. Among customers who purchase lunch, for example, some customers purchase lunch from 10:00 to 14:00 while other customers purchase lunch from 12:00 to 13:00. The time zone recognized as “daytime” may thus be different for each customer. The estimation unit 102 may therefore change the segment of each time zone for each piece of the customer information. Specifically, the estimation unit 102 may learn a boundary of a purchase pattern in one day for each piece of the customer information, and set a period from a start time to an end time of the purchase pattern as the segment of the time zone.

The estimation unit 102 may also classify the purchase date and time indicated by the date and time information into any season, and estimate the classified season as the purchase purpose. This is because it is assumed that the purchase range varies depending on the season due to changes in weather, customer preferences, product assortment, and the like. The estimation unit 102, for example, classifies the purchase date and time from March to May as “spring”, and classifies the purchase date and time from June to August as “summer”. The estimation unit 102 also classifies the purchase date and time from September to November as “autumn”, and classifies the purchase date and time of December, January, or February as “winter”.

In this case, segments of the respective seasons may be fixed or may be different for each piece of the customer information. This is because, similar to the time zone, recognition of season may be different for each customer. The estimation unit 102 may therefore change the segment of each season for each piece of the customer information. Specifically, the estimation unit 102 may learn the boundary of a purchase pattern in one year for each piece of the customer information, and set a period from a start date to an end date of the purchase pattern as the segment of the season.

The estimation unit 102 may also estimate, as the purchase purpose, information obtained by combining two or more of the time zone, the season, and the product category (for example, morning-beverage, daytime-staple food, morning-summer, morning-autumn, morning-winter, or daytime-autumn-beverage). The estimation unit 102 then passes the history information added with the purchase purpose to the generation unit 103.

The generation unit 103 generates the learning data from the history information added with the purchase purpose, which is passed from the estimation unit 102. A format of the learning data varies depending on a clustering method used by the extraction unit 104.

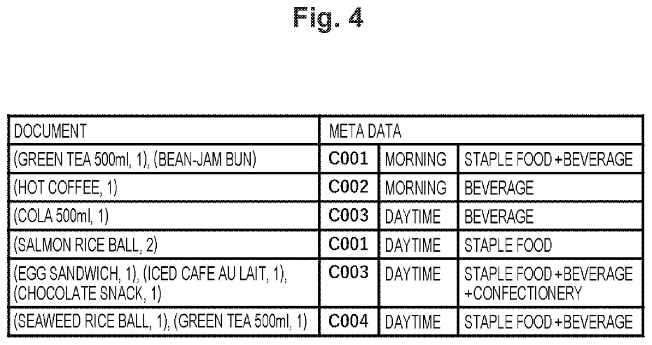

For example, in a case where the extraction unit 104 uses a method such as a latent dirichlet allocation (LDA) method, which is frequently used in topic analysis, a dirichlet multinomial regression model, which is a derivative model of the LDA method, or the like, as illustrated in FIG. 4, the generation unit 103 generates the learning data in which a purchase content (a document) in one purchase is set as one record and added with customer information and the purchase purpose (the time zone and the product category, in the example illustrated in FIG. 4) as metadata.

Here, the LDA method is described in detail in Reference Literature 1 below.

### Reference Literature 1

Blei, D. M., Ng, A. Y., & Jordan, M. I. (2003). Latent dirichlet allocation. Journal of machine Learning research, 3 (January), 993-1022.

Further, the dirichlet multinomial regression model is detailed in Reference Literature 2 below.

### Reference Literature 2

Mimno, D., & McCallum, A. (2012). Topic models conditioned on arbitrary features with dirichlet-multinomial regression. arXiv preprint arXiv: 1206.3278.

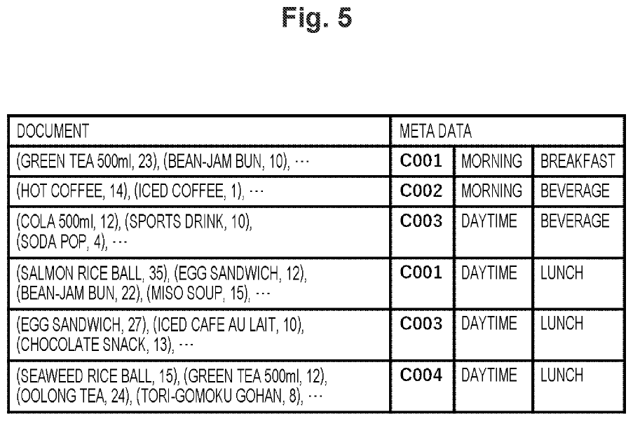

As illustrated in FIG. 5, the generation unit 103 may also generate the learning data in which all purchase contents during a learning period are aggregated into one record (one document), for each purchase purpose of the customer and added with customer information and the purchase purpose (the time zone and the product category, in the example illustrated in FIG. 5) as metadata.

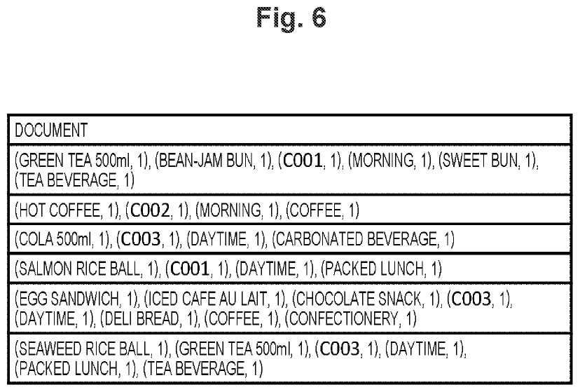

Further, the extraction unit 104 can calculate similarity between the products and between the customers and execute clustering by regarding each of the product name, the customer information, and the purchase purpose as a word and learning a word vector. For example, in a case where the extraction unit 104 learns the word vector using a bag-of-words model, as illustrated in FIG. 6, the generation unit 103 generates, as the learning data, data in which the product name, the customer information, and the purchase purpose are integrated into one sentence.

Here, the word vector is described in detail in Reference Literature 3 below.

### Reference Literature 3

T. Mikolov, K. Chen, G. Corrado, and J. Dean (2013). Efficient Estimation of Word Representations in Vector Space. In Proc. of Workshop at the International Conference on Learning Representations (ICLP).

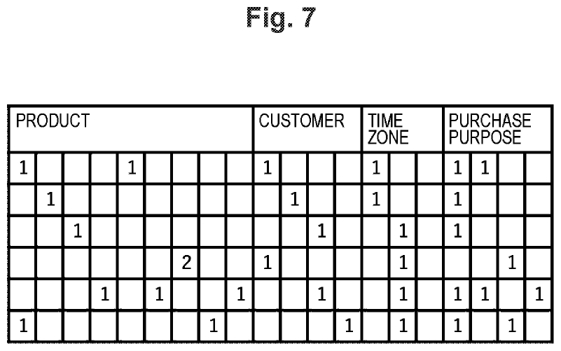

The extraction unit 104 can also execute clustering using a factorization machine model which is one of methods used for recommendation. The factorization machine is a method proposed for the purpose of collaborative filtering added with metadata, which is capable of learning a customer group added with a customer information and a purchase purpose and learning a product group. In this case, as illustrated in FIG. 7, the generation unit 103 generates as the learning data a matrix obtained by connecting a product purchase matrix and purchase purpose information to each other.

Here, the factorization machine is described in detail in Reference Literature 4 below.

### Reference Literature 4

Rendle, S. (2010). Factorization machines. (2010) IEEE International Conference on Data Mining (pp. 995-1000).

Note that the methods described above are examples of implementing clustering, and are not limited to these methods. Further, the example of the learning data described above is merely an example, and are not limited thereto. The generation unit 103 then passes the generated learning data to the extraction unit 104.

The extraction unit 104 clusters the learning data passed from the generation unit 103 on the basis of the purchase purpose to extract product groups, and extracts customer groups on the basis of similarity of the product groups extracted for each of a plurality of the customers.

Specifically, the extraction unit 104 clusters, for each customer information, the product information using the purchase purpose as metadata. The extraction unit 104 extracts, for example, “a balance bar group” and “a carbonated beverage group” as the product groups to be purchased in the morning and extracts “a Japanese-style rice ball and healthy packed lunch group” and “a vegetable juice group” as the product groups to be purchased in the daytime by a customer A. The extraction unit 104 also extracts “a tea group” as a product group to be purchased by the customer A in any time zone.

The extraction unit 104 then reads a learning model (for example, a topic model), and clusters, on the basis of similarity of the products included in the product group, the product groups extracted from a plurality of pieces of the customer information of the entire store. As a result, the extraction unit 104 can extract the customer groups having similar preferences and the product groups to be purchased by the customer groups in order to achieve the purchase purpose (for example, “a balance bar group”, “a healthy lunch box group”, and the like).

Note that, depending on the product group, an element of the time zone may remain or may not remain in the extracted product groups. For example, the element of the time zone remains in the product groups having a common tendency such as the plurality of customers purchase the product group in the morning or evening. For the product groups purchased in any time zone, on the other hand, the extraction unit 104 cancels the element of the time zone when clustering the product group on the basis of the similarity of the products.

The extraction unit 104 then passes the learning model to the model management unit 105.

The extraction unit 104 also calculates for each product group, using the history database 200, a number of unique users during the learning period (a number of store visitors for purchasing the product group), a number of product types included in the product group, a number of. sales during the learning period of the product group, and total sales of the product group during the learning period. The extraction unit 104 also calculates for each product group, using the history database 200, a number of unique users per day, a number of sales per day, distribution of the customers included in the associated customer group, and distribution of the products included. The extraction unit 104 then passes these pieces of information to the result display unit 106.

The model management unit 105 stores, in the ROM 12 or the storage 14, the learning model passed from the extraction unit 104. The model management unit 105 also reads model data having a designated file name. The model management unit 105 also displays a list of the learned model data on the display unit 16. The model management unit 105 also deletes the designated model data from the ROM 12 or the storage 14. Note that, in a case where the learning model is the topic model, the learning model is data including a number of topics, a parameter of each state, metadata, a learned prior distribution parameter for each metadata, an appearance probability of each product in each topic, and the like.

The result display unit 106 displays on the display unit 16 the number of unique users during the learning period, the number of product types included in the product group, the number of sales during the learning period of the product group, and the total sales of the product group during the learning period, which are passed from the extraction unit 104.

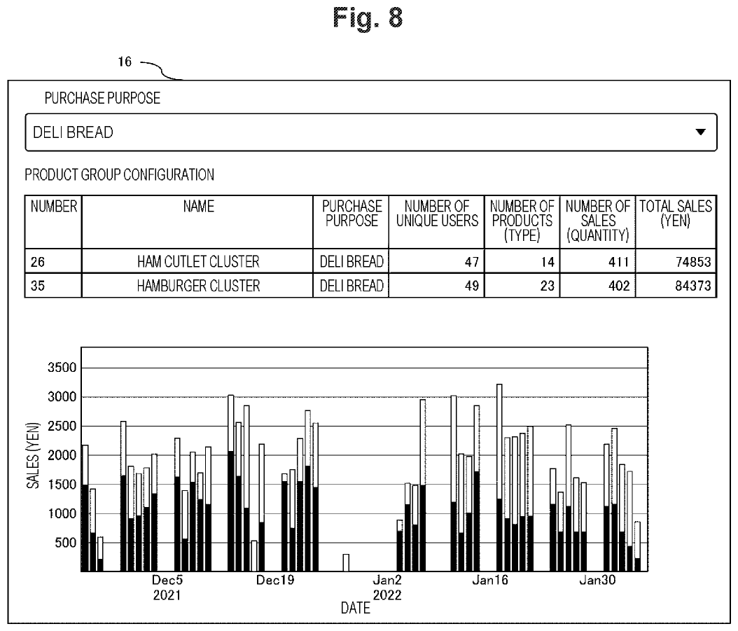

FIG. 8 illustrates an example of a cluster screen displayed by the result display unit 106. As illustrated in FIG. 8, for each product group associated with the purchase purpose, the number of unique users during the learning period, the number of product types included, the number of sales during the learning period, and the total sales during the learning period are displayed on the cluster screen. In the example illustrated in FIG. 8, for example, in a case where the purchase purpose is “deli bread”, a product group of deli bread with fried food, such as a thick-cut ham cutlet roll (hereinafter, referred to as “a ham cutlet cluster”) and a product group of deli bread without fried food, such as a double hamburger bread (hereinafter, referred to as “a hamburger cluster”) are associated with the deli bread. In addition, as to the ham cutlet cluster, the number of unique users is 47, the number of product types is 14, the number of sales is 411, and the total sales is 74853 yen, during the learning period. As to the hamburger cluster, on the other hand, the number of unique users is 49, the number of product types is 23, the number of sales is 402, and the total sales is 84373 yen, during the learning period.

The cluster screen also displays daily sales for each product group. In the lower diagram of FIG. 8, a white bar graph indicates the daily sales of the ham cutlet cluster, and a black bar graph indicates the daily sales of hamburger cluster.

The result display unit 106 also displays on the display unit 16 the number of unique users per day of the product group, the number of sales per day of the product group, the distribution of the customers included in the customer group associated with the product group, and the distribution of the products included in the product group, which are delivered from the extraction unit 104.

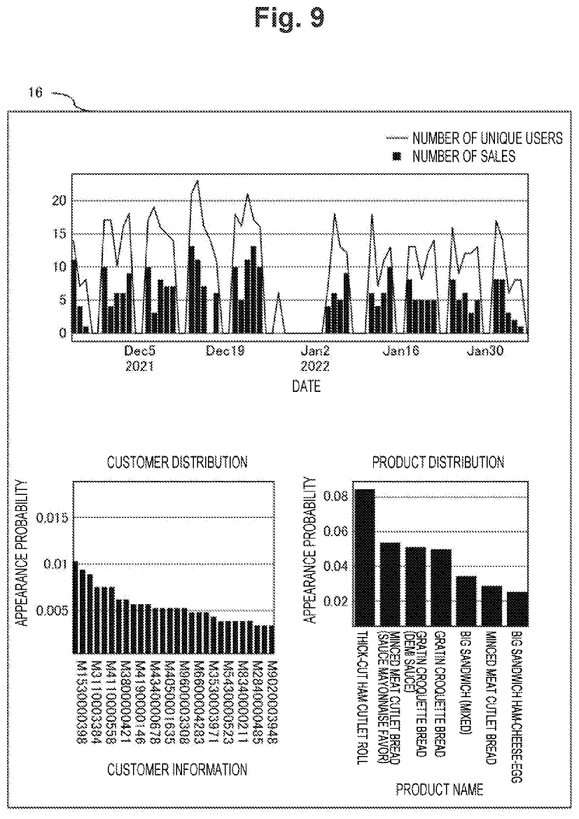

FIG. 9 illustrates an example of a ham cutlet cluster screen displaying a ham cutlet cluster. The polygonal line in the upper diagram of FIG. 9 indicates the number of unique users of the ham cutlet cluster per day, and the bar graph indicates the number of sales of the ham cutlet cluster per day. The lower left diagram in FIG. 9 illustrates the appearance probability of each piece of the customer information of the customer group associated with the ham cutlet cluster. The lower right figure in FIG. 9 illustrates the appearance probability for each product name of the product associated with the ham cutlet cluster. As illustrated in the lower right figure in FIG. 9, the ham cutlet cluster includes, in addition to the thick-cut ham cutlet roll, a minced meat cutlet bread, a gratin croquette bread, and the like.

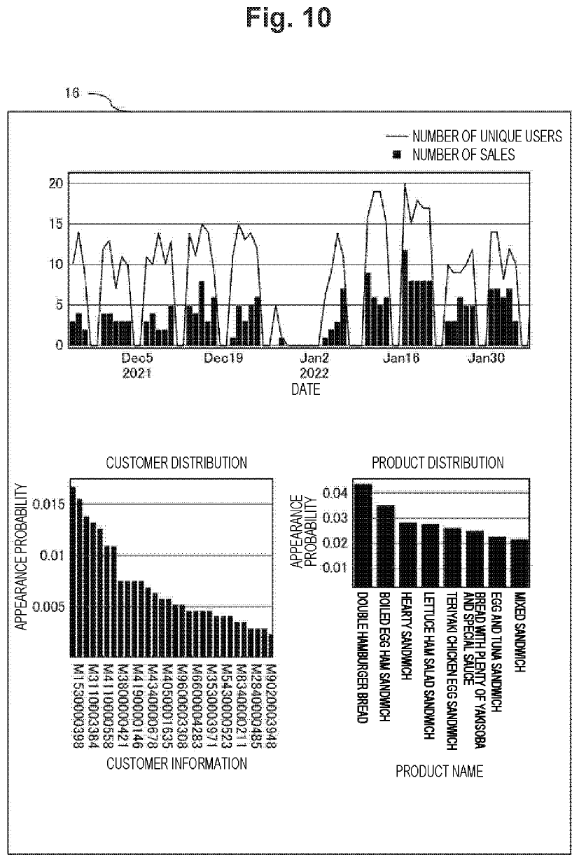

FIG. 10 illustrates an example of a hamburger cluster screen displayed for a hamburger cluster. The polygonal line in the upper diagram of FIG. 10 indicates the number of unique users of the hamburger cluster per day, and the bar graph indicates the number of sales of the hamburger cluster per day. The lower left diagram in FIG. 10 illustrates the appearance probability of each piece of the customer information of the customer group associated with the hamburger cluster. The lower right figure in FIG. 10 illustrates the appearance probability of each product name associated with the hamburger cluster. As illustrated in the lower right figure of FIG. 10, the hamburger cluster includes, in addition to the double hamburger bread, a boiled egg ham sandwich, a hearty sandwich, and the like.

A store manager can grasp the preference of the customer groups of the store, a scale of each customer group, and the products purchased by each customer group by having the result display unit 106 displaying these screens. Further, it is possible to implement sales promotion measures in accordance with the preference of the customer by the store manager performing sales promotion on a customer list associated with the customer group.

Demand prediction for each product group is another application form of the present technology. As described above, the extracted product groups are the products purchased by the customer groups associated with the product groups in order to achieve the purchase purpose. That is, it is assumed that demand of the customer groups are shared by the products in the product groups associated with the customer groups, so that the demand is more stable than predicting the demand for each product. Further, even if the product runs out, it is considered that an alternative purchase is likely to occur in the product group, which lowers the possibility of impairing sales opportunities.

The store manager needs to place an order for each product in order to actually replenish products. The store manager can calculate a required quantity for each product by multiplying the predicted sales number of the product group by a ratio of the past sales number of the product, for example.

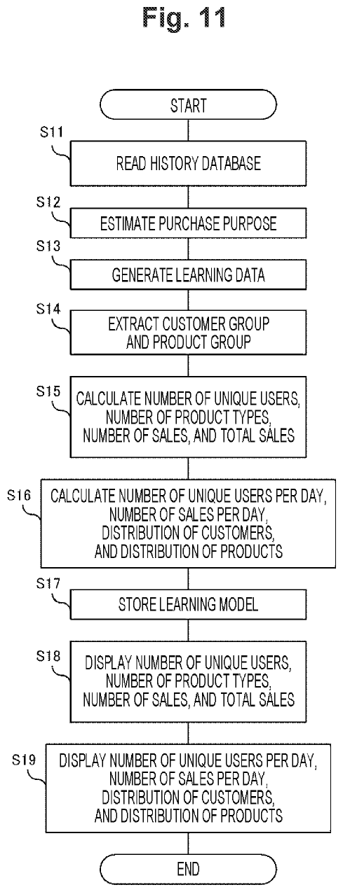

Next, actions of the product group and customer group extraction device 10 will be described. FIG. 11 is a flowchart illustrating a flow of the product group and customer group extraction processing carried out by the product group and customer group extraction device 10. The product group and customer group extraction processing is carried out by the CPU 11 reading the product group and customer group extraction program from the ROM 12 or the storage 14, developing the product group and customer group extraction program in the RAM 13, and executing the product group and customer group extraction program.

In step S11, the CPU 11 as the management unit 100 reads the history database 200.

In step S12, next, the CPU 11 as the estimation unit 102 estimates the purchase purpose on the basis of the history information. Specifically, the estimation unit 102 estimates, as the purchase purpose, the product category, the time zone, the season, or information obtained by combining two or more of these pieces of information.

In step S13, next, the CPU 11 as the generation unit 103 generates the learning data from the history information added with the purchase purpose.

In step S14, next, the CPU 11 as the extraction unit 104 extracts the customer groups having similar preferences and the product groups to be purchased by the customer groups in order to achieve the purchase purpose. Specifically, the CPU 11 clusters for each customer information the product information using the purchase purpose as metadata. The CPU 11 then reads the learning model, and clusters, on the basis of the similarity of the products included in the product groups, the product groups extracted from the plurality of pieces of customer information of the entire store.

In step S15, next, the CPU 11 as the extraction unit 104 calculates for each product group the number of unique users during the learning period, the number of product types included, the number of sales during the learning period, and the total sales during the learning period.

In step S16, next, the CPU 11 as the extraction unit 104 calculates for each product group the number of unique users per day, the number of sales per day, the distribution of the customers included in the associated customer group, and the distribution of the products included.

In step S17, next, the CPU 11 as the model management unit 105 stores the learning model in the ROM 12 or the storage 14.

In the step S18, next, the CPU 11 as the result display unit 106 displays on the display unit 16 the number of unique users during the learning period, the number of product types included in the product group, the number of sales during the learning period of the product group, and the total sales of the product group during the learning period.

In step S19, next, the CPU 11 as the result display unit 106 displays on the display unit 16 the number of unique users per day of the product group, the number of sales per day of the product group, the distribution of the customers included in the customer group associated with the product group, and the distribution of the products included in the product group. Then, the product group and customer group extraction processing ends.

Here, the collaborative filtering, which is mainly used for product recommendation, is a method of calculating the similarity between the customers and the similarity between the products on the basis of the purchase history of the customers. The collaborative filtering typically is a technique that has been developed for the purpose of calculating a purchase trend from a sparse purchase matrix of an unspecified number of customers and products, such as an online store, which does not particularly consider a difference in purchase content in accordance with a purchase situation of a customer and the like.

The purchases intended for purchasing the daily sales products as assumed this time are, on the other hand, characterized in that the purchase range greatly differs depending on the customers'purchase purpose. For example, in a certain store, appealing in the morning a customer, who purchases a beverage in the morning and purchases a night meal in the evening, for a product group that can be served as a late night snack does not meet the purpose of the customer, so that the appeal effect is low. In the purchase intended for purchasing the daily sales products, therefore, it is important to estimate the purchase purpose of the customer and learn the purchase range for each purchase purpose.

Further, for example, in a case where the customer A visits the store to purchase a salmon rice ball for lunch and finds out the salmon rice ball is out of stock, it is assumed that the customer A attempts to satisfy demand for lunch with another product. As described above, there are multiple candidate products in a purchase for food or the like. In the example described above, shortage of the salmon rice ball does not directly affect the sales of the store when another product is sold instead of the salmon rice ball. That is, when there are product groups as a range of products to be purchased by a customer in order to achieve the purchase purpose and the product that belongs to the product group serves as a buffer for another product, it is only necessary to perform demand prediction in units of the product group. Also, improvement in accuracy of demand prediction can be expected by summarizing sales of multiple products. Further, the store manager can grasp, by extracting the customer groups having similar purchase tendencies, by what customer segment having what preference the sales of the store are configured, which can improve replenishment of products including new products.

Analysis of purchase histories of multiple retail stores revealed that the customers'purchase purposes are classified according to the time zone, the product category, or the season, particularly in convenience stores or the like in office areas. It was also revealed that the customers purchase products from a certain product group for each purchase purpose. Also, there was a product group common to the plurality of customers and it was suggested that clustering by customer preference is possible.

Specifically, in two stores open from 9:00 to 21:00, the time zone was classified into “morning” from 9:00 to 11:00, “daytime” from 11:00 to 14:00, “evening” from 14:00 to 17:00, and “night” from 17:00 to 21:00, and purchase trends of customers'were verified.

As a result, for example, there was a tendency that the customer A purchased a balance bar-type snack and vegetable juice in the morning, a staple food such as a rice ball, a packed lunch, or a cup noodle and a snack such as a cream puff in the daytime, and a refreshing beverage such as a carbonated beverage in the evening. Further, there was a tendency that a customer B, who purchases confectionery, purchased gum in the morning and purchased crispy and filling confectionery, such as rice crackers and nuts, in the evening.

In summary, as to food, there was a common tendency among the plurality of customers that food as breakfast is purchased in the morning, food as lunch is purchased in the daytime, confectionery is purchased in the evening, and food as night meal is purchased at night. Also, as to beverages, there was a common tendency among the plurality of customers that tea or coffee is purchased in the morning, favorite products such as a carbonated beverage and an energy drink is purchased in the evening, and supplement type beverages such as vegetable juice or a protein beverage which is a part of a meal was purchased from the morning to the daytime. As described above, it was revealed that the product groups associated with the purchase purpose can be extracted by classifying the purchase history by the time zone.

The estimation unit of the product group and customer group extraction device according to the present embodiment therefore estimates the purchase purpose for which the customer has purchased the product, on the basis of the history information including the customer information for identifying the customer, the product information on the product purchased by the customer, and the date and time information of purchase of the product. Also, the generation unit of the product group and customer group extraction device according to the present embodiment generates the learning data from the history information added with the purchase purpose. Also, the extraction unit of the product group and customer group extraction device according to the present embodiment clusters the learning data for each customer on the basis of the purchase purpose to extract product groups, and extracts the customer groups on the basis of the similarity of the product groups extracted for each of the plurality of customers. As a result, the possibility of discarding products, in stores where it is difficult to predict the demand for each product, can be reduced by enabling grasping of a customer structure of the store, marketing, and demand prediction.

### MODIFICATION EXAMPLE

The foregoing embodiment described the case where the management unit, the cluster extraction unit, and the result display unit are implemented by a single computer (the product group and customer group extraction device). The components may be, however, implemented by different computers.

Further, the product group and customer group extraction processing executed by the CPU reading software (a program) in the foregoing embodiment may be executed by various processors other than the CPU. Examples of the processors in this case include a programmable logic device (PLD) in which a circuit configuration can be changed after manufacturing, such as a field-programmable gate array (FPGA) or the like, and a dedicated electric circuit or the like that is a processor having a circuit configuration exclusively designed for executing a specific process, such as an application specific integrated circuit (ASIC). Further, the product group and customer group extraction processing may be carried out by one of these various processors, or may be carried out by a combination of two or more processors of the same type or different types (for example, multiple FPGAS, a combination of a CPU and an FPGA, and the like). Further, a hardware structure of these various processors is, more specifically, an electric circuit in which circuit elements such as semiconductor elements are combined.

Further, the foregoing embodiment described the mode in which the product group and customer group extraction program is stored (installed) in advance in the ROM 12 or the storage 14; however, the present embodiment is not limited thereto. The program may be provided in a form stored in a non-transitory storage medium such as a compact disk read only memory (CD-ROM), a digital versatile disk read only memory (DVD-ROM), a universal serial bus (USB) storage medium. Further, the program may be downloaded from an external device via a network.

The following supplementary notes are further disclosed with regard to the foregoing embodiment.

### Supplementary Note 1

A product group and customer group extraction device including
a memory; and
at least one processor connected to the memory, in which
the processor is configured to:
estimate a purchase purpose for which a customer has purchased a product, on the basis of history information including customer information for identifying the customer, product information on the product purchased by the customer, and date and time information of purchase of the product;
generate learning data from the history information added with the purchase purpose; and
cluster the learning data for each customer on the basis of the purchase purpose to extract product groups, and extract customer groups on the basis of similarity of the product groups extracted for each of a plurality of the customers.

### Supplementary Note 2

A non-transitory recording medium storing a program that can be executed by a computer to execute a product group and customer group extraction processing, in which
the product group and customer group extraction processing includes:
estimating a purchase purpose for which a customer has purchased a product, on the basis of history information including customer information for identifying the customer, product information on the product purchased by the customer, and date and time information of purchase of the product;
generating learning data from the history information added with the purchase purpose; and
clustering the learning data for each customer on the basis of the purchase purpose to extract product groups, and extracting customer groups on the basis of similarity of the product groups extracted for each of a plurality of the customers,

### REFERENCE SIGNS LIST

10 Product group and customer group extraction device
11 CPU
12 ROM
13 RAM
14 Storage
15 Input unit
16 Display unit
17 Communication I/F
19 Bus
100 Management unit
101 Cluster extraction unit
102 Estimation unit
103 Generation unit
104 Extraction unit
105 Model management unit
106 Result display unit
200 History database

1. A product group and customer group extraction device comprising a processor configured to execute operations comprising:
estimating, based on history information, a purchase purpose of a purchase of a product, product information, and date and time information of the purchase of the product, wherein the purchase purpose is of which a customer has purchased the product, the history information comprises customer information of the customer, the product information is of the product purchased by the customer;
generating learning data from the history information and the purchase purpose of respective customers of a plurality of customers, wherein the respective customers comprise the customer;
extracting, based on the purchase purpose in the learning data, by clustering the learning data, a plurality of product groups associated with the respective customers, wherein the plurality of product groups comprises a product group, and the product group comprises the product purchased by the customer; and
extracting, based on similarity among the plurality of product groups associated with the respective customers, a customer group, wherein the customer group comprises the customer.

2. The product group and customer group extraction device according to claim 1, wherein
the estimating further comprises estimating a category of the product as a part of the product information of the product indicates the purchase purpose.

3. The product group and customer group extraction device according to claim 1, wherein
the estimating further comprises classifying a purchase time in the date and time information into a time period, and estimating the time period as a part of the purchase purpose.

4. The product group and customer group extraction device according to claim 3, wherein
the estimating further comprises updating a segment of each time period for a respective piece of the customer information.

5. The product group and customer group extraction device according to claim 1, wherein
the estimating further comprises classifying a purchase date and time in the date and time information into a season, and estimating the classified season as a part of the purchase purpose.

6. The product group and customer group extraction device according to claim 1, the processor further configured to execute operations comprising:
displaying, on a display, a number of store visitors per day for receiving a product in the product group in exchange for a resource, a number of receiving resources received per day in exchange for the product the product group, distribution of the respective customers in the customer group relative to the product group, and distribution of a plurality of products in the product group, wherein the plurality of products comprises the product.

7. A method for extracting a product group and a customer group, comprising
estimating, based on history information, a purchase purpose of a purchase of a product, product information, and date and time information of the purchase of the product, wherein the purchase purpose is of which a customer has purchased the product, the history information comprises customer information of the customer, the product information is of the product purchased by the customer;
generating learning data from the history information and the purchase purpose of respective customers of a plurality of customers, wherein the respective customers comprise the customer;
extracting, based on the purchase purpose in the learning data, by clustering the learning data, a plurality of product groups associated with the respective customers, wherein the plurality of product groups comprises a product group, and the product group comprises the product purchased by the customer; and
extracting, based on similarity among the plurality of product groups associated with the respective customers, a customer group, wherein the customer group comprises the customer.

8. A computer-readable non-transitory recording medium storing a computer-executable program instructions that when executed by a processor cause a computer system to execute operations comprising:
estimating, based on history information, a purchase purpose of a purchase of a product, product information, and date and time information of the purchase of the product, wherein the purchase purpose is of which a customer has purchased the product, the history information comprises customer information of the customer, the product information is of the product purchased by the customer;
generating learning data from the history information and the purchase purpose of respective customers of a plurality of customers, wherein the respective customers comprise the customer;
extracting, based on the purchase purpose in the learning data, by clustering the learning data, a plurality of product groups associated with the respective customers, wherein the plurality of product groups comprises a product group, and the product group comprises the product purchased by the customer; and
extracting, based on similarity among the plurality of product groups associated with the respective customers, a customer group, wherein the customer group comprises the customer.

9. The product group and customer group extraction device according to claim 6, wherein the displaying further comprises graphically presenting the number of store visitors per day through a graphical user interface.
